(19) United States
(12) Patent Application Publication
(10) Pub. No.: US 2024/0123503 A1
(43) Pub. Date: Apr. 18, 2024

(54) TUNED SUPPORT GEOMETRIES FOR ADDITIVE MANUFACTURING SUPPORT REMOVAL AND METHODS OF USE THEREOF

(71) Applicant: Divergent Technologies, Inc., Los Angeles, CA (US)

(72) Inventors: Gordon TAJIRI, Los Angeles, CA (US); Michael Thomas KENWORTHY, Rancho Palos Verdes, CA (US)

(21) Appl. No.: 18/484,319

(22) Filed: Oct. 10, 2023

Related U.S. Application Data
(60) Provisional application No. 63/414,854, filed on Oct. 10, 2022.

(51) Int. Cl. B22F 10/47; B22F 10/30; B22F 10/60; B33Y 10/00; B33Y 30/00; B33Y 40/20; B33Y 50/02

(52) U.S. Cl. CPC B22F 10/47; B22F 10/30; B22F 10/60; B33Y 10/00; B33Y 30/00; B33Y 40/20; B33Y 50/02

(57) ABSTRACT

Systems and methods of forming and removing support structures formed in a powder bed fusion (PBF) system are provided. The support structures are formed with designated failure zones that are designed to fail in a controlled fashion when resonated by one or more resonation devices.

### CROSS-REFERENCE TO RELATED APPLICATION

This application claims priority to U.S. Provisional Application No. 63/414,854 filed on Oct. 10, 2022, titled: Dynamically Tuned Local Support Geometries for Combined Powder and Support Removal, the entirety of which is incorporated by reference herein.

### FIELD

The present disclosure relates generally to additive manufacturing, and more particularly, to the formation and removal of support structures for additive manufacturing.

### BACKGROUND

Additive manufacturing (AM) systems can produce metal structures (referred to as build pieces) with geometrically complex shapes, including some shapes that are difficult or impossible to create with conventional manufacturing processes. (AM) techniques are used to create build pieces layer-by-layer, i.e., slice-by-slice. Each layer or slice can be formed by a process of depositing a layer of metal powder and fusing (e.g., adhering, and/or melting and cooling) areas of an additive material that coincide with the cross-section of the build piece in the layer. The process can be repeated to form the next slice of the build piece, and so on. Because each layer is deposited on the previous layer, AM can be likened to forming a structure slice-by-slice and allows for the formation of structures that were previously not possible to be formed by traditional machining (i.e., subtractive manufacturing) technologies.

The shape of some build pieces can cause undesirable results in the finished piece. For example, some shapes include overhangs or other structures that require support during formation. In this regard, support structures can be used to mitigate or prevent problems associated with overhangs or other structures that require support. Conventional techniques for addressing these problems, however, require significant effort to remove support structures and/or unfused during post-processing and have significant disadvantages and shortcomings in their own rite.

### SUMMARY

The following presents a simplified summary of one or more aspects of the invention in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

In some aspects of this disclosure, the techniques described herein relate to a device for processing an additively manufactured component and support structure, the device including: a resonation device for resonating at least the additively manufactured component or support structure, wherein the resonation device is configured to resonate the support structure at a frequency that causes structural failure and separation of the support structure from the additively manufactured component.

The techniques described herein further relate to a device for processing an additively manufactured component, the device including: a resonation device for resonating least one of the additively manufactured component or an additively manufactured support structure connected to the additively manufactured component, wherein the resonation device is configured to resonate at least the support structure or component at a frequency that separates non-fused additive media from the additively manufactured component.

In some additional aspects of the disclosure, the techniques described herein relate to a method of additively manufacturing a build piece and a support structure for mechanically supporting at least part of the build piece, the method including: layered fusing of a powdered build material to form the support structure; and layered fusing of the powdered build material to form the build piece; wherein the support structure is formed with a failure zone proximal to the build piece, wherein the failure zone is configured to structurally fail and separate from the build piece when subjected to resonation by a resonation device.

In an additional aspect of the disclosure, the techniques described herein relate to a non-transitory computer-readable medium storing computer-executable instructions for additive manufacturing, the instructions executable by a processor to control an additive manufacturing apparatus to perform: layered fusing of a powdered build material to form a support structure for a build piece; and layered fusing of the powdered build material to form the build piece; wherein the support structure is formed with a failure zone proximal to the build piece, wherein the failure zone is configured to structurally fail and separate from the build piece when subjected to resonation by a resonation device.

Other aspects will become readily apparent to those skilled in the art from the following detailed description, wherein is shown and described only several exemplary embodiments by way of illustration. As will be realized by those skilled in the art, concepts described herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various characteristic and aspects of the technology described herein are set forth as follows, in the appended claims, and in the drawings. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative aspects when read in conjunction with the accompanying drawings.

FIGS. 1A-D illustrate respective side views of an example Powder Bed Fusion (PBF) system usable with aspects of the disclosure during different stages of operation according to aspects of the disclosure.

FIG. 2 illustrates one example of a drooping deformation in a PBF system.

FIG. 3 illustrates one example of a support structure according to aspects of the disclosure.

FIG. 4 illustrates a second example of a support structure according to aspects of the disclosure.

FIG. 5 illustrates a third example of a support structure according to aspects of the disclosure

FIG. 6A illustrates an example partial cross-sectional view of a support structure according to aspects of the disclosure.

FIG. 6B illustrates an example partial cross-sectional view of a support structure at a failure zone according to aspects of the disclosure.

FIG. 6C illustrates one example of defects that may be intentionally introduced into resonant structures according to aspects of the disclosure.

FIG. 6D illustrates a simplified diagram of one of a plurality of resonant structures that may be formed at the failure zone of a support structure according to aspects of the disclosure.

FIG. 7 illustrates some examples of control parameters of the PBF system that can be modified to introduce defects at the failure zone while forming support structures according to aspects of the disclosure.

FIG. 8 illustrates one example resonation apparatus according to aspects of the disclosure.

FIG. 9 illustrates a second example of a resonation apparatus according to aspects of the disclosure.

FIG. 10 illustrates a third example of a resonation apparatus according to aspects of the disclosure.

FIG. 11 illustrates an example representative diagram of various components of an example controller usable with aspects of the disclosure.

FIG. 12 illustrates an example of a computer system in accordance with aspects of the disclosure.

FIG. 13 illustrates an example of various system components in accordance with aspects of the present disclosure.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

### I. Terminology

Reference throughout this specification to one aspect, an aspect, one example or an example means that a particular feature, structure or characteristic described in connection with the embodiment or example may be a feature included in at least example of the present invention. Thus, appearances of the phrases in one aspect, in an aspect, one example or an example in various places throughout this specification are not necessarily all referring to the same example. Furthermore, the particular features, structures or characteristics may be combined in any suitable combinations and/or subcombinations in one or more embodiments or examples.

Throughout the disclosure, the terms substantially or approximately may be used as a modifier for a geometric relationship between elements or for the shape of an element or component. While the terms substantially or approximately are not limited to a specific variation and may cover any variation that is understood by one of ordinary skill in the art to be an acceptable level of variation, some examples are provided as follows. In one example, the term substantially or approximately may include a variation of less than 10% of the dimension of the object or component. In another example, the term substantially or approximately may include a variation of less than 5% of the object or component. If the term substantially or approximately is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

For purposes of the disclosure, directional terms are expressed generally with relation to a standard frame of reference when the aspects or articles described herein are in an in-use orientation. In some examples, the directional terms are expressed generally with relation to a left-hand coordinate system.

Terms such as a, an, and the, are not intended to refer to only a singular entity, but also include the general class of which a specific example may be used for illustration. The terms a, an, and the, may be used interchangeably with the term at least one. The phrases at least one of and comprises at least one of followed by a list refers to any one of the items in the list and any combination of two or more items in the list. All numerical ranges are inclusive of their endpoints and non-integer values between the endpoints unless otherwise stated.

The terms first, second, third, and fourth, among other numeric values, may be used in this disclosure. It will be understood that, unless otherwise noted, those terms are used in their relative sense only. In particular, certain components may be present in interchangeable and/or identical multiples (e.g., pairs). For these components, the designation of first, second, third, and/or fourth may be applied to the components merely as a matter of convenience in the description.

The terms powder bed fusion (PBF) is used throughout the disclosure. PBF systems may encompass a wide variety of additive manufacturing (AM) techniques, systems, and methods. Thus, the PBF system or process as referenced in the disclosure may include, among others, the following printing techniques: direct metal laser sintering (DMLS), electron beam melting (EBM), selective heat sintering (SHS), selective laser melting (SLM) and selective laser sintering (SLS). PBF fusing techniques may further include, for example, solid state sintering, liquid phase sintering, partial melting, full melting, chemical binding and other binding and sintering technologies. Still other PBF processes to which the principles of this disclosure are pertinent include those that are currently contemplated or under commercial development. The aspects of the disclosure may additionally be relevant to non-metal additive manufacturing and or metal/adhesive additive manufacturing (e.g., binderjetting), which may forgo an energy beam source and instead apply an adhesive or other bonding agent to form each layer. In the case of binderjetting, the cured or green form may be sintered or melted together in a furnace and/or be infiltrated with bronze or other alloys.

The term fusing may be used throughout the disclosure to describe any temporary or permanent fixing or adhering of AM powder or other known materials. In some examples, the term fusing may include sintering, melting, and/or adhering (e.g., via bonding agent or adhesive) individual powder particles.

### II. Detailed Examples

Powder bed fusion (PBF) systems can produce structures (referred to as build pieces) with geometrically complex shapes, including some shapes that are difficult or impossible to create with conventional manufacturing processes. PBF systems create build pieces layer-by-layer, i.e., slice-by-slice. Each slice can be formed by a process of depositing a layer of powder (e.g., metal or metallic powder) and fusing (e.g., melting and cooling) areas of the metal powder layer that coincide with the cross-section of the build piece in the slice. The process can be repeated to form the next slice of the build piece, and so on.

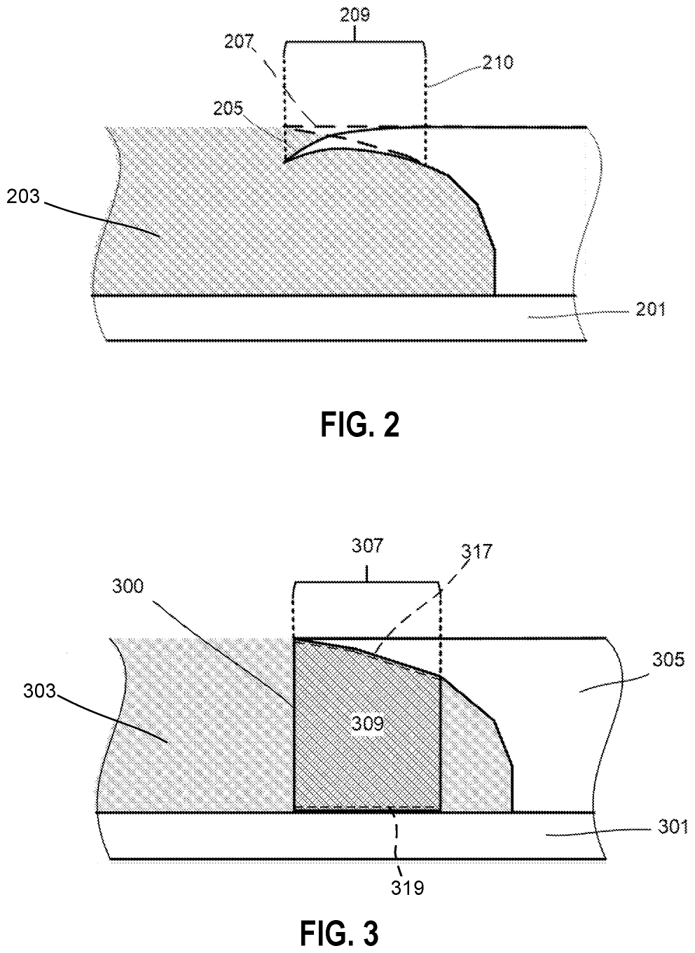

The shape of some build pieces can produce undesirable results in the finished piece. For example, some shapes include overhangs, which include portions of the build piece that are formed by melting powder on top powder that is not fused. A simple example of an overhang is shown in FIG. 2, wherein a portion of the overhang area 209 may be subject to the effects of gravity, which left unattended, may cause the raised portion to sag or otherwise deform.

In this regard, support structures can be used to mitigate or prevent problems associated with overhang areas. Described herein are various systems, apparatuses, and methods for creation of support structures in PBF systems and for removal of support structures from build pieces, as well as various novel configurations of support structures. In the context of AM and associated PBF techniques, support structures may be used to offset or otherwise mitigate the undesirable consequences of overhanging structures prone to deformation or other problems. Support structures are distinct from (although they may be connected to) the build piece and in some cases may be fused to the build piece. Some support structures can provide a mechanical link between the support plate (also referred to a build plate) and the build piece, stabilizing structures that are overhung relative to the main structure of the build piece. These types of support structures can be constructed, for example, much like the build piece itself, in that a plurality of layers of powder can be deposited and melted together, sintered, or otherwise solidified or partially solidified in an area generally beneath and/or partially or fully surrounding an anticipated overhang, with each layer being solidified sufficiently to provide support for the overhang to be rendered in subsequent passes of the energy beam source during ensuing print cycles. Depending on the specific AM technique employed, the methods of forming mechanically linked layers may vary. Various measures may be undertaken to remove the support material from the build piece. Particularly in the context of complex geometrical structures, such an undertaking may present its own set of challenges. For example, in the past a technician would have to cut-off the support structure, an additional step which reduced efficiency in producing products using AM. As described in detail below, aspects described herein relate to apparatuses, systems, and method for forming support structures with designated failure zones that are designed to fail in a controlled fashion when resonated by a resonation device.

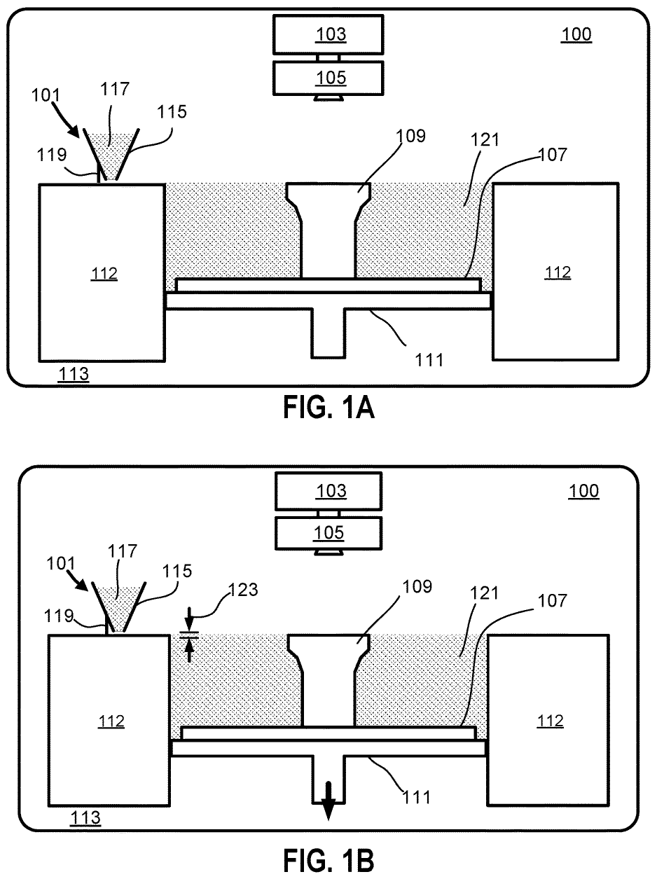

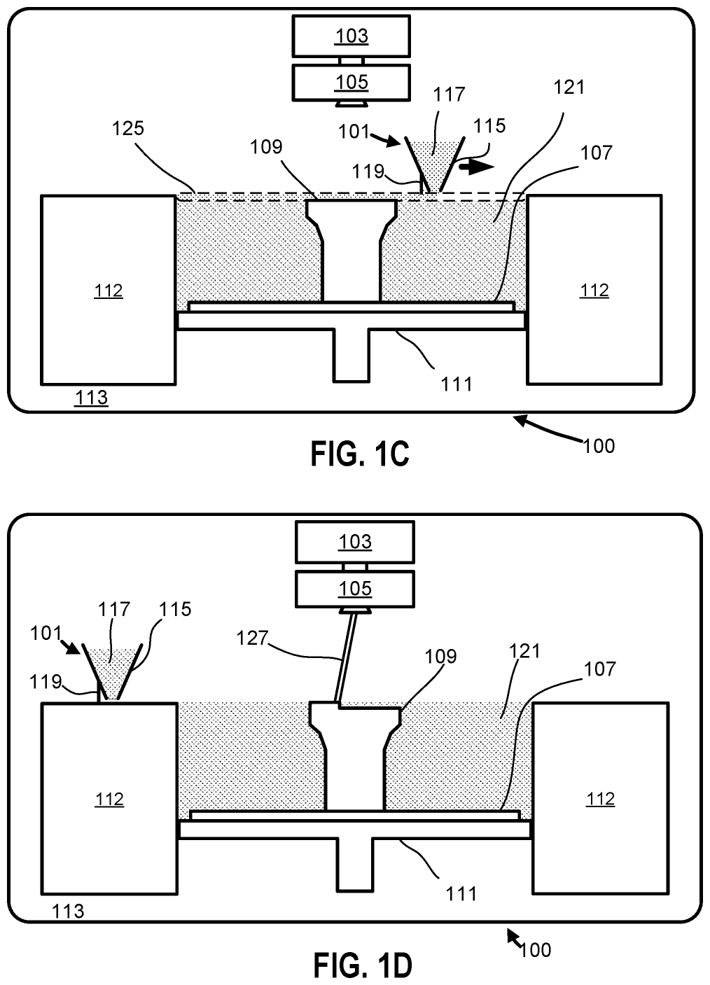

FIGS. 1A-D illustrate respective side views of an example of a PBF system 100 usable with aspects of the disclosure during different stages of operation. As noted above, the particular embodiment illustrated in FIGS. 1A-D is one of many suitable examples of a PBF system employing principles of this disclosure. It should also be noted that elements of FIGS. 1A-D and the other figures in this disclosure are simplified and not necessarily drawn to scale, but may be drawn larger or smaller and/or with reduced detail for the purpose of better illustration of concepts described herein. PBF system 100 can include a depositor 101 that can deposit each layer of metal powder, an energy beam source 103 that can generate an energy beam, a deflector 105 that can direct or redirect the energy beam to fuse the powder material, and a build plate 107 that can support one or more build pieces, such as a build piece 109. PBF system 100 can also include a build floor 111 positioned within a powder bed receptacle. The walls of the powder bed receptacle 112. Build floor 111 can progressively lower build plate 107 so that depositor 101 can deposit a next layer. In some examples, the entire mechanism may reside in a chamber 113 that can enclose the other components, thereby protecting the equipment, enabling atmospheric (e.g., providing an inert environment) and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused by the , but before the next layer of powder has been deposited. In fact, FIG. 1A illustrates a time at which PBF system 100 has already deposited and fused a partially completed build piece in multiple layers to form the current state of build piece 109. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 moves over the defined space while releasing powder 117 from hopper 115. Leveler 119 can level the released powder to form a powder layer 125 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to melt, sinter, and/or melt the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 may include an optical system that uses reflection and/or refraction to manipulate the laser beam to scan selected areas to be fused. In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various aspects of the disclosure, the energy beam can be modulated by a digital signal processor (DSP). The deflector may include any known system in the art, for example a galvo-scanner or galvanometer, and/or a raster scanner. It is noted that while a single energy beam source 103 and/or deflector 105 is shown, aspects of the disclosure are usable with and may include a system with multiple energy source(s) and/or deflector(s).

As shown in FIG. 1D, much of the fusing of powder layer 125 occurs in areas of the powder layer that are on top of the previous slice, i.e., previously-fused powder. An example of such an area is the surface of build piece 109. The fusing of the powder layer in FIG. 1D is occurring over the previously fused layers characterizing the substance of build piece 109. However, in some areas of powder layer 125, fusing can occur on top of loose powder—namely, over powder that was not fused—inadvertently or otherwise. For example, if the slice area is bigger than the previous slice area, at least some of the slice area will be formed over loose powder. Applying the energy beam to melt an area of powder over loose powder can be problematic. Melted powder is liquefied and generally denser than loose powder. The melted powder can seep down into the loose powder causing drooping, curling, or other unwanted deformations in the build piece 109. Because loose powder can have low thermal conductivity, higher temperatures than expected can result when fusing powder in overhang areas because the low thermal conductivity can reduce the ability for heat energy to conduct away from the fused powder during fusing. Higher temperatures in these areas result in higher residual stresses after cooling and, more often than not, a poor quality build piece. In some cases, these residual stresses can cause portions of the build piece to curl upwards, which can protrude from the powder bed and collide with the depositor when the next layer of material is deposited. In some cases, dross formations can occur in overhang areas thereby resulting in undesired surface roughness or other quality problems.

FIG. 2 illustrates a side view of one example of a drooping or sagging deformation in a PBF system that can result in unsupported overhang areas. FIG. 2 shows a build plate 201 and a powder bed 203. In powder bed 203, is an example of an actual build piece 205. A model build piece 207 is illustrated by a dashed line for the purpose of comparison. In one embodiment, model build piece 207 includes data from the data model created in CAD for use as an input to the AM processor to render the build piece. Model build piece 207 shows the desired shape of the build piece. Actual build piece 205 overlaps model build piece 207 in most places, i.e., in places that have no deformation. Thus, in areas to the right of overhang boundary 210, the solid line characterizing the actual build piece 205 overlaps with the dashed line defined in the model build piece 207. However, a drooping deformation occurs in an overhang area 209. In this example, overhang area 209 is formed from multiple slices fused on top of one another. In this case, the deformation worsens as overhang area 209 extends from the bulk of actual build piece 205. As the actual build piece 205 in FIG. 2 illustrates, some build piece shapes can therefore require the use of support structures in order to mitigate or prevent deformations and other problems that can result in overhang areas.

It should be noted that some problems, such as deformations, higher residual stresses, etc., can occur in areas in which powder in one layer is fused near the edge of the slice in the layer below, even though the fusing does not occur directly over loose powder. For example, unexpectedly high temperatures can result when fusing powder near the edge of a slice below because there is less fused material below to conduct heat away. These problems can be particularly severe where the slices below form a sharp edge. In this regard, support structures may be used to mitigate or prevent deformations and other problems that can result in these areas near overhang areas as well. As used herein, the terms “overhang area” and the like are intended to include areas near overhang areas and over fused powder, such as described above in areas adjacent the fusing of powder near the edge of a slice below, in areas where slices form sharp corners or edges, and similar areas that can potentially result in the above-described array of unwanted overhang artifacts in the subject build piece.

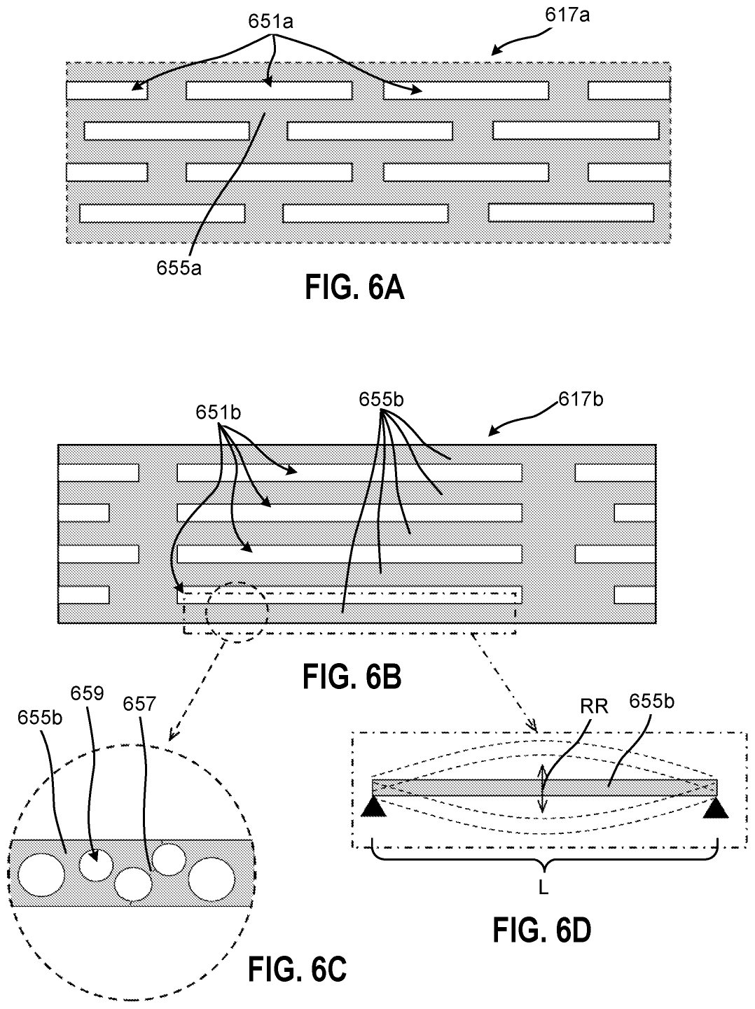

FIGS. 3-5 illustrate example systems, methods, and configurations for support structures, in which particles of loose powder can be fused or otherwise bound to the build piece in areas that require a support to control the effects described above. FIGS. 6A-10 are related to methods for removal of support structures according to aspects to the disclosure.

FIG. 3 is a side view of one example of a fused-powder support structure 300. FIG. 3 shows a build plate 301 and a powder bed 303. In powder bed 303, is a build piece 305 that includes an overhang area 307. In powder bed 303, under the portion of build piece 305 in overhang area 307, there is a region of fused powder 309. As described above, fused powder can include melted powder, bound powder compacted powder, partially sintered powder, powder with a binding agent applied, etc. Fused powder 309 can form support structure 300 that supports the portion of build piece 305 in overhang area 307. In this way, for example, support structure 300 formed of fused powder 309 mitigates or prevents deformations and other unwanted artifacts of build piece 305. As shown in FIG. 3, one example of a support structure may include a lattice structure which includes fused powder and loose powder.

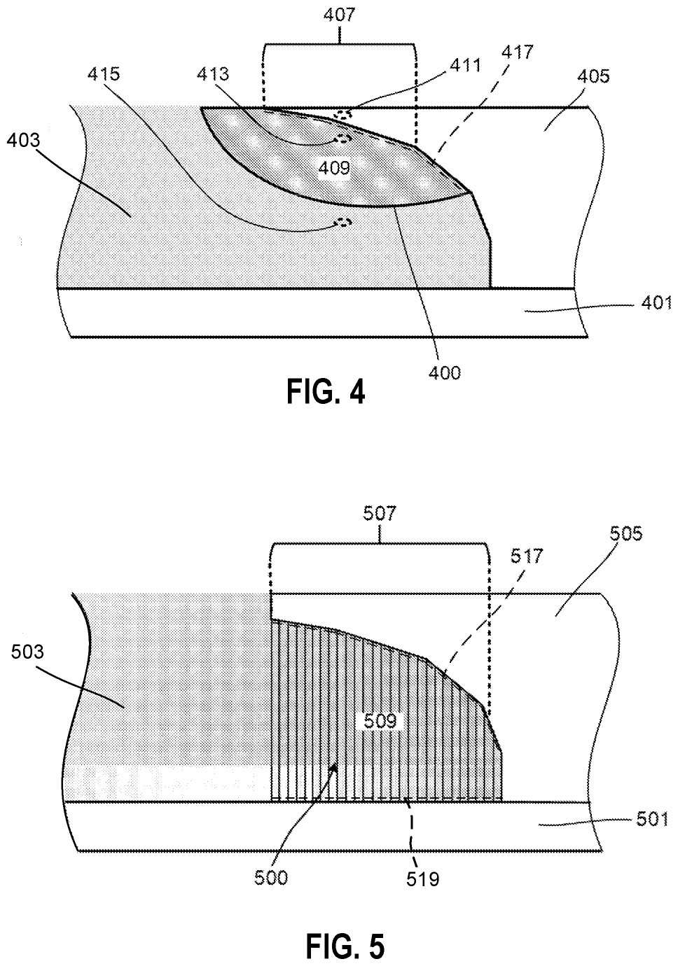

FIGS. 4-5 illustrate respective side views of additional examples of a build piece and support structure, which may be formed using a PBF apparatus. FIG. 5 illustrates a side view of another example configuration of a support structure 400 in an overhang area 407 of powder bed 403. The build piece may be partially supported by build plate 401. The powder bed 403 may also be supported by the build plate 401. The build piece 405 may include an overhang area 407 or other portion that requires support to maintain acceptable quality of the build piece 405. In this example, support structure 400 can be formed of a region of fused powder 409 that is connected to the build piece 405. In this example configuration, support structure 600 does not extend down to build plate 401. Thus, support structure 400 and the overhang area 407 are supported solely by loose or compacted powder. However, support structure 400 can support build piece 605 because the support structure can ‘float’ on loose powder in powder bed 603. More specifically, fused powder 409 can be formed to increase the surface area of fused powder contacting the loose or compacted powder so that deformation forces acting on build piece 405 can be distributed to a greater area of loose or compacted powder. In this way, the force can be distributed in such a way that the loose powder underneath support structure 400 can provide an adequately non-deformable link between the support structure 400 and build plate 401. Therefore, support structure 400 can effectively support portions of build piece 405 in overhang area 407 even though the support structure does not extend all of the way to build plate 401. In the configuration of FIG. 4, for example, an area of fused powder 411 is above an area of fused powder 413, which is above an area of non-fused powder 415. The aforementioned type of support structure allows for less powder to be used to form support structures, which among other benefits, reduces build time and allows more powder to be recovered and reused. These factors collectively result in cost savings, manufacturing efficiency, and potential time to market advantages.

In addition, the aforementioned support structures may allow additional build pieces to be built more efficiently during a single PBF AM run. For example, additional build pieces may be built in the spaces of loose powder below anchored support structures, i.e., in the spaces in which other support structures would ordinarily extend through to reach down to the build plate. In another example, a fused powder region 409 having a comparatively large area 413, a second adjacent component (not shown) may be constructed adjacent build piece 405 using an opposite side of fused powder region 409 as a support structure for overhang support. These examples potentially allow for a much greater ability to render more types of build pieces in a comparatively shorter time.

FIG. 5 is a side view of another example of a fused-powder support structure 500. FIG. 5 shows a build plate 501 and a powder bed 503. In powder bed 503, is a build piece 505, which may be analogous with and/or share similarities with build piece 109 in FIGS. 1A-1D, build piece 205 in FIG. 2, build piece 305 in FIG. 3, and/or build piece 409 in FIG. 4. The build piece 505 may include an overhang area 307 and/or other portion that may require support. In powder bed 503, under the portion of build piece 505 in overhang area 507, there is a region of fused powder 509 for supporting the overhang area 507. As described above, fused powder can be, for example, melted or sintered powder, partially sintered powder, and/or powder with a binding agent applied. Fused powder 509 can form support structure 500 that supports the portion of build piece 505 in overhang area 507. In this way, for example, support structure 500 formed of fused powder 509 mitigates or prevents of build piece 505. One example of a support structure may include a single or multiple branched structures or series of vertically and/or substantially vertically oriented supports which includes fused powder and loose powder.

As further shown in the examples of FIGS. 3-5, support structures according to aspects of the disclosure may include failure zones (e.g., failure zones 317, 319, 417, 517 and/or 519). The failure zones may be formed proximal to the build piece and/or at or near a desired outer surface of the finished build piece so that when the support structure is removed using the techniques described below, all of or the majority of the support structure separates from the build piece at the failure zone. Further, failure zones may be formed at or near the build plate (e.g., build plates 301 in FIG. 3 and/or build plate 519 in FIG. 5). The failure zone at the build plate may allow the support structure and/or build piece to be removed from the build plate using a resonation device as described in further detail below.

The failure zone (e.g., 317 and/or 319 in FIG. 3, 417 in FIG. 4 and/or 517 and/or 519 in FIG. 5) of the support structure (e.g. 300, 400, 500) may include any one or combination of structures formed (e.g., by fusing powder using the methods and apparatuses described above) with a resonance geometry and/or with intentionally formed defects of the support structure at or near the failure zone. In some aspects of the disclosure, the tuned geometries may be formed to additionally improve removal of excess loose powder from the build piece. The support structure may have resonant support structures that are formed so that vibration of the resonant support structures in their natural frequency causes the support structure to break away from the build piece and/or the build plate. This can be due, for example, to metal fatigue at the interface between the support structure and the build piece and/or build plate.

Thus, by implementing the features and methods described herein, post-processing step (e.g., powder removal, support removal, and/or build piece removal) may simplified and/or fully or partially automated resulting in improvements in efficiency and cost. In some examples, the build piece and any necessary support structures may be formed with a PBF device as described above, once the build piece and necessary supports are completed, both the supports and unfused powder may be removed by a resonation device, which may be integrated with or otherwise associated with the PBF device.

In other aspects, the build piece and supports (and any unfused powder) may be removed from the PBF device and placed into or connected to or contacted by a resonation device. The resonation device may apply one or more resonant frequencies causing mechanical failure of the connection between the support structure and the build piece at the failure zone. The resonation may additionally remove or separate unfused powder from the build piece.

FIG. 6A is an example partial cross-sectional view of a support structure 617a. The support structure 617a may include sections of unfused powder 651a between sections of fused powder 655b. FIG. 6B is an example partial cross-sectional view of a support structure 617b at a failure zone (e.g., failure zones 317 and/or 319 in FIG. 3, 417 in FIG. 4, or 517 and/or 519 in FIG. 5). The support structure 617b at a failure zone include or may be formed to include fused powder in the form of resonant structures 655b. The resonant structures 655b may be elongated and/or may otherwise include geometries that resonate (i.e., in directions RR) when subjected to a resonance force.

FIG. 6D is a simplified diagram of one of a plurality of resonant structures that may be formed at the failure zone 617b of a support structure. As shown in FIG. 6D, when the resonant structures 655b are subjected to a bending frequency resonation force, the resonant structure 655b may oscillate as indicated by the broken lines in FIG. 6D.

In one example, the bending frequency fₙ of resonant structures 655b may be calculated using equation (F) below.

$${f}_{0} = {\frac{1}{2 π} [ \frac{n π}{L} ]}^{2} \sqrt{\frac{EI}{ρ}} , n = 1 , 2 , 3 , … \qquad ( F )$$

In equation (F) above, variable E is the modulus of elasticity, I is the internal moment of inertia, L is the length, ρ is the mass density (mass/length) and P is the applied force. More specifically, the natural resonance bending frequency and/or any one of or combination of the length, mass density, and/or modulus of elasticity of resonant structures 655b can be calculated using equations (F-1) to (F-61) in the Equation Table submitted herewith. The entirety of the aforementioned Equation Table is incorporated by reference herein.

In some examples, the bending resonation frequency of the resonant structures 655b may be from 50 Hertz (Hz) to 1000 Hz. In another example, the resonation frequency of the resonant structures 655b may be 100-900 Hz. In yet another example, the resonation frequency of the resonant structures 655b may be 200-900 Hz.

In some examples, the build piece and/or the support structure may be subject to low frequency (e.g., the frequencies noted above for maximum deflection (e.g., as shown in FIG.6) of the resonant structures 655b and may additionally be subject to a second higher-frequency to induce high-cycle fatigue stress. The aforementioned high frequency may range from 900-2000 Hz. In another example, the frequency may range from 950-1950 Hz. In yet another example, the frequency range may be 1100-1900 Hz. Combining high frequencies with low frequencies (e.g., when applying resonation via a resonation device described in further detail below) may increase the efficiency of separating the support structure(s) from the build piece and/or the build plate. For example, simultaneously applying a high frequency and low frequency to the build piece and/or support structure may reduce the time required to separate the aforementioned structures.

It is noted that while an elongated resonant structure is shown in FIG. 6D, the any known resonant structure may be formed into the support structure (e.g., a beam with a center mass, cantilever with or without end mass). Further, the resonant structures 655b may be tapered or otherwise thinned-out in geometry at or near a desired fracture zone or area. Additional non-limiting examples are provided in the above-mentioned Equation Table and throughout this disclosure.

In some examples, the resonant structures 655b may be half-wave resonators configured to swing or otherwise resonate when a resonation frequency is applied thereto. As shown in the example of FIG. 6D, applying a resonation force at a resonation frequency or frequency range causes the resonant structures 655b to resonate (e.g., in directions RR). The resonation of the resonant structures 655b may result in controlled failure of the resonant structures 655b in the support structure 617b in a designated or pre-determined failure zone (e.g., failure zones 317 and/or 319 in FIG. 3, 417 in FIG. 4, or 517 and/or 519 in FIG. 5) causing the support structure to fully or partially separate from the build piece and/or build plate, which eliminates or simplifies the step of removing support structures from a build piece during post processing of a PBF or AM built build piece.

In some implementations, resonance may also be used to remove unfused powder from the support structure and/or build piece. For example, as the resonant structures 655b resonate, any unfused powder may be vibrated free from the build piece and/or support structure. Combining the separation of support structures with removal of unfused powder further improves efficiency of post processing.

Just as resonant structures 655b can be formed to resonate at a specific frequency or range of frequencies to provide controlled failure of the support material in the failure zone of the support structure, resonant structures may additionally be formed to resonate at a frequency that facilitates the removal of unfused powder. For example, the resonant structures 655b may be formed to resonate at a frequency of 900-2000 Hz. In another example, the frequency may range from 950-1950 Hz. In yet another example, the frequency range may be 1100-1900 Hz.

In some example implementations, defects may be intentionally introduced into the support structure during the PBF or AM build process to facilitate the separation of support structures from the build piece and/or from the build plate or even other support structures. FIG. 6C shows one example of defects 659 that are introduced into the resonant structures 655b. The defects 659 introduced into the support structure 617b cause a weakening of the fused support structure and propagation of cracks 657 in the support structure 617b when the resonant structures 655b deflect. In other words, a reduction in material fracture toughness due to defects 659 allows for the controlled failure and separation of the support structure when subjected to deflection (e.g., as shown in FIG. 6D) caused by resonance of the resonant structures 655b.

In the example shown in FIG. 6C, the defects 659 may be formed in the resonant structures 655b at a failure zone (e.g., failure zones 317 and/or 319 in FIG. 3, 417 in FIG. 4, or 517 and/or 519 in FIG. 5) of the support structure. In one example, the defects 659 may be caused by controlling the PBF system to introduce porosity and/or lack of fusion in the support structure at or near the desired failure zones.

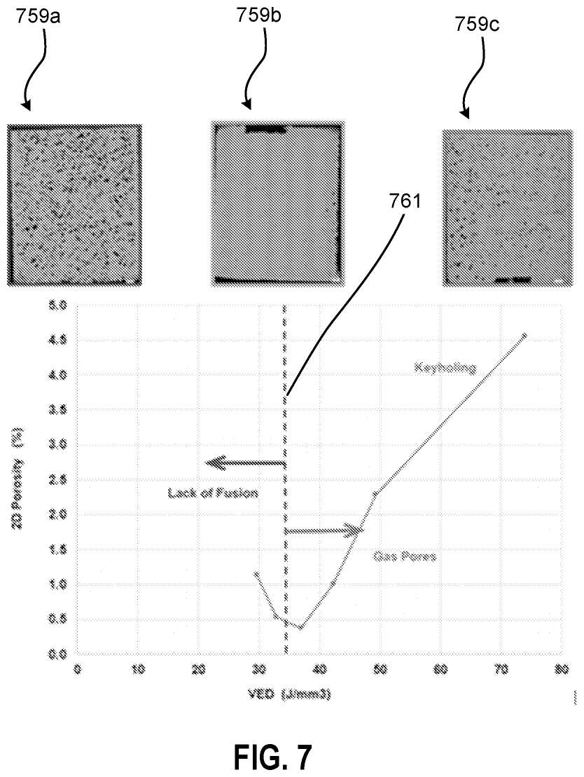

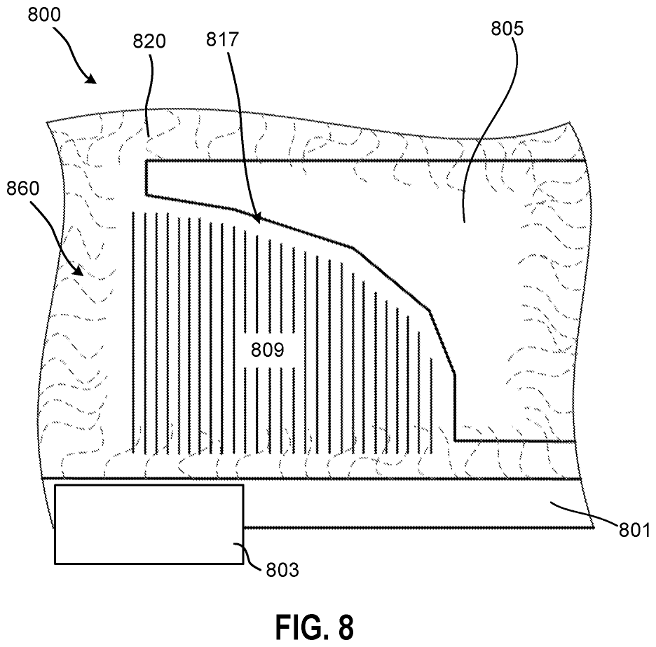

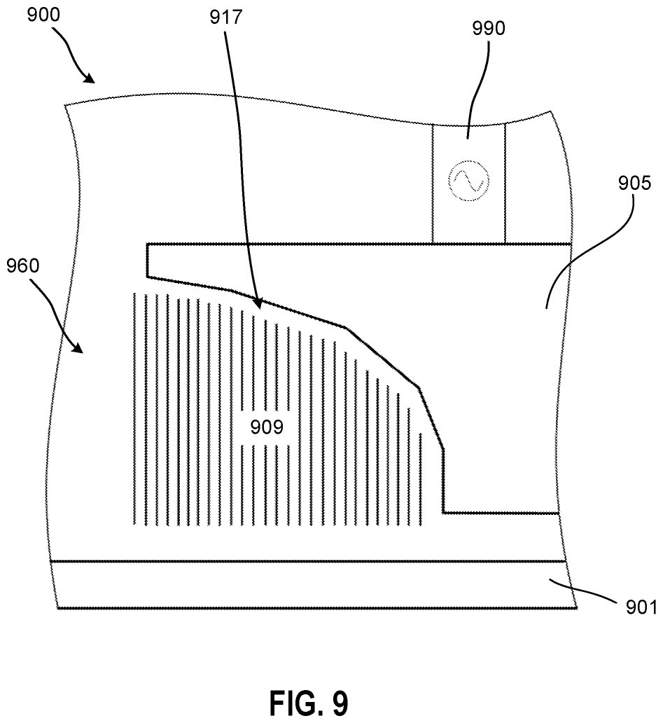

FIG. 7 shows some examples of control parameters of the PBF system that can be modified to introduce defects 659 while forming support structures. The X axis of the chart in FIG. 7 represents the volumetric energy density (VED) of a PBF system during formation of the build piece and/or support structures(s). The Y axis represents a percentage of porosity in the fused material. Generally, when forming a build piece, the goal is to minimize porosity to improve the structural properties of the build piece. As shown in FIG. 7, line 761 indicates one example of a VED value that results in minimal porosity of the build piece as shown by cross-section 759b. Increasing or decreasing the VED beyond the optimal ranges results in porosity, and thus a decrease in strength of the build, either due to lack of fusion (e.g., as shown in cross-section 759a) or results in porosity due to gas pores and/or keyholing (e.g., as shown in cross-section 759c)

The VED may be a parameter of the energy beam source 103 (FIGS. 1A-1D) and/or the deflector 105 and/or the thickness of the powder layer provided by the depositor 101. In one example, VED in joules/millimeters³ (J/mm³) is defined by equation G below, wherein E is a power of an energy source used to fuse the powdered build material, S is a scan speed of the energy source, L is a thickness of unfused powder build material, and H is a hatch spacing of the energy source used to fuse the powdered build material.

$$VED = \frac{E}{S \times L \times H} \qquad ( G )$$

As shown in FIG. 7, a VED of 30-40 J/mm³ reduces defects that occur during fusion of powder during a build process. When the VED increases above 40 J/mm³ or decreases below 30 J/mm³, defects such as lack of fusion, gas pores, and/or keyholing may occur in the fused material. Thus, by increasing or decreasing the VED, defects (e.g., defects 659 in FIG. 6C) can be intentionally introduced into the support structure at a desired failure zone (e.g., failure zones 317 and/or 319 in FIG. 3, 417 in FIG. 4, or 517 and/or 519 in FIG. 5).

In one example implementations of the disclosure, the PBF system may be controlled so that the VED at the failure zone and/or at resonant structures (e.g., resonant structures 655b in FIGS. 6B and 6D) may be 40-80 J/mm³. In another example, the VED may be 45-80 J/mm³. In yet another example, the VED may be 55-80 J/mm³.

In another example implementation, the PBF system may be controlled so that the VED at the failure zone and/or at resonant structures (e.g., resonant structures 655b in FIGS. 6B and 6D) may be 1-35 J/mm³. In another example, the VED may be 20-35 J/mm³. In yet another example, the VED may be 20-30 J/mm³. By increasing the VED as described above, lack of fusion defects may be introduced into the support structure to allow for controlled failure at the failure zone as described above.

In some example implementations of the disclosure, the PBF system may be controlled so that the VED when forming layers of the build (i.e., support structure) at the failure zone is 20-40% higher than a VED when forming a layer of the build piece. Similarly, the VED may also be lower at the failure zone than what is optimal for forming a build piece. For example, the VED when forming a layer of the build (i.e., the resonant structures of the support structure) at the failure zone may be 20-40% lower than a VED when forming a layer of the build piece

FIGS. 8-10 show examples of vibration or resonation features that are usable with the aspects described above to remove support structure(s) (e.g., support structures 300 in FIG. 3, 400 in FIG. 4, 500 in FIG. 5, and/or 617a and 617b in FIGS. 6A-6B) from the build piece (e.g., build piece 109 in FIGS. 1A-1D, build piece 305 in FIG. 3, build piece 405 in FIG. 4, build piece 505 in FIG. 5) and/or build plate (e.g., build plate 107 in FIGS. 1A-1D, build plate 301 in FIG. 3, build plate 401 in FIG. 1, and/or build plate 501 in FIG. 5) and/or to separate unfused powder (e.g., powder in powder bed 121 in FIGS. 1A-1D, powder in powder bed 203 in FIG. 2, powder in powder bed 303 in FIG. 3, powder in powder bed 403 in FIG. 4, powder in powder bed 503 in FIG. 5 and/or unfused powder 651a and/or 651b in FIGS. 6A-6D) from the build piece and/or support structures. The examples described below may be integrated into the PBF system (e.g., PBF system 100 in FIGS. 1A-1D) to allow post-formation separation of the support structure, build plate, and/or loose powder at the same PBF system that the build piece is formed with. In another example, the vibration or resonation features may be a separate resonation processing apparatus that a user may place the build piece into or onto to be post-processed. In another example, an automated system such as robot or conveyor may transfer the build piece to the resonation processing system.

FIG. 8 shows one example apparatus 800 for resonating at least one of the build piece 805 and/or additively manufactured support structure 809 connected thereto. In the example of FIG. 8, the device may have a container 860 configured to contain a liquid 820 (e.g., water, deionized water, and/or a detergent). The apparatus 800 may have one or more oscillators/transducers 801 that oscillate when electrical current is provided to the transducer 801. The electric current may be provided at a controlled frequency and/or frequencies via an ultrasonic generator 803. The oscillator/transducer 801 may configured to induce propagating waves and/or cavitation to the liquid 820. The propagating waves in liquid 820 resonate the support structure and/or loose powder and cause separation or partial separation of the support structure 809 from the build piece 805 due to failure of the material at the failure zone 817 as described above.

In some examples, the transducer 801 may be controlled to induce resonation waves in liquid 820 at the resonation frequency and/or half resonation frequency of the resonant structures (e.g., 655b in FIGS. 6B-6D) at the failure zone 817 (e.g., failure zones 317 and/or 319 in FIG. 3, 417 in FIG. 4, or 517 and/or 519 in FIG. 5) of the support structure 809. In some examples, the ultrasonic generator 803 may be controlled to induce vibrations from 50 Hertz (Hz) to 1000 Hz to the liquid 820. In another example, the ultrasonic generator 803 may induce vibrations from 100-900 Hz. In yet another example 200-900 Hz. In some examples, the ultrasonic generator may induce higher-frequency vibrations either concurrently with and/or before and/or after the aforementioned frequencies. Some examples of higher-frequency vibrations may be 900-2000 Hz, 950-1950 Hz and/or 1100-1900 Hz. Combining high frequencies with low frequencies may increase the efficiency of separating the support structure(s) 809 from the build piece 805 and/or a build plate. For example, simultaneously applying a high frequency and low frequency to the build piece and/or support structure may reduce the time required to separate the aforementioned structures. In some examples, the liquid 820 may be supplied to the PBF system 100 (FIG. 1A-1D) after the build piece 109 is completed and/or at a designated time during the build. Unfused powder in powder bed 121 may be removed prior to providing the liquid 860.

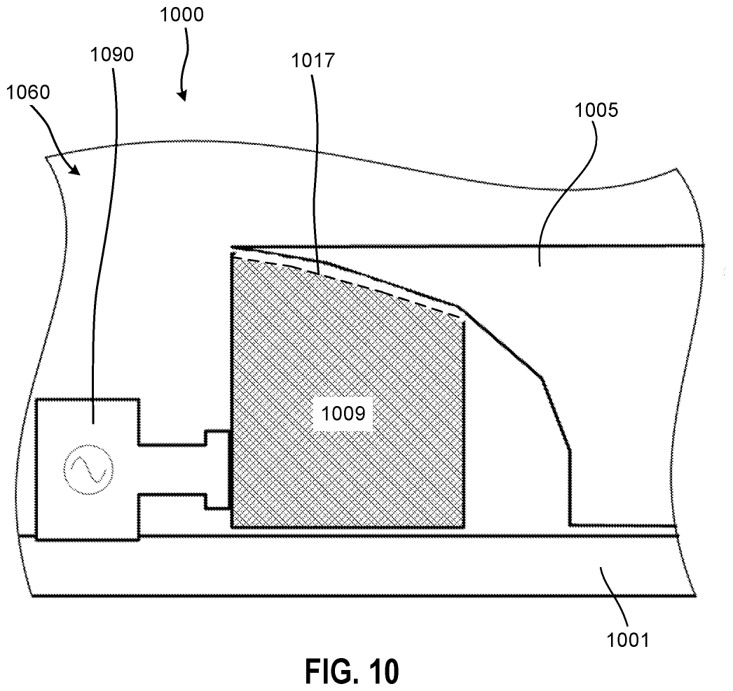

FIGS. 9 and 10 show other examples of resonation devices and vibration or resonation features that are usable with the aspects described above. FIG. 9 shows an example system and method that includes a resonation device 900 with a resonator and/or vibrator 990 that can apply a resonance frequency for removing support structures 909 and/or unfused powder. The vibrator 990 may cause mechanical excitation via for example any one or combination of ultrasound transducers, piezoelectric transducers micro electro-mechanical systems, to name a few non-limiting examples. FIG. 9 shows a build plate 901 and a build piece 905. It is noted that while the support structure 809 is indicated as a vertical extension type support structure, the features described are applicable to any type of support structure. For example, the resonator may be used to remove any one or combination of the support structure 300 in FIG. 3, 400 in FIG. 4, 500 in FIG. 5, and/or 617a and 617b in FIGS. 6A-6B.

The resonator/vibrator 990 can be coupled to base build piece 905 such that a resonance frequency can be applied to cause the support structures 909 to vibrate or resonate. In some examples, the resonator/vibrator 990 may apply a resonation at a resonance frequency or half-resonance frequency of resonance structures (e.g., resonance structures 655b in FIGS. 6B-6D). The resonance may cause failure, and thus separation, of the fused support at a designated failure zone 917. The designated failure zone may share similarities with or may be analogous with the failure zones 317 and/or 319 in FIG. 3, 417 in FIG. 4, or 517 and/or 519 in FIG. 5, for example. The vibrator 990 may be controlled to induce vibrations from 50 Hertz (Hz) to 1000 Hz. In another example, the vibrator 990 may induce vibrations from 100-900 Hz. In yet another example 200-900 Hz. In some examples, the vibrator 990 may induce higher-frequency vibrations either concurrently with and/or before and/or after the aforementioned frequencies. Some examples of higher-frequency vibrations may be 900-2000 Hz, 950-1950 Hz and/or 1100-1900 Hz. Combining high frequencies with low frequencies may increase the efficiency of separating the support structure(s) 909 from the build piece 905 and/or a build plate 901. In various aspects, the vibrator 990 may induce a first frequency that is tuned to cause vibrations of the support structure that are more effective at removing unfused powder, e.g., a relatively lower frequency to cause greater deflection of the resonant structures of the support structure (e.g., resonant structures 655b). In various embodiments, after the unfused powder is removed, the vibrator 990 may induce a second frequency that is tuned to cause vibrations of the support structure that are more effective at causing fatigue and breaking the support structure, e.g., a relatively higher frequency to cause a higher rate of deflection back and forth of the resonant structures to induce high-cycle fatigue stress. In some examples, the two aforementioned frequencies may be applied simultaneously and/or to partially overlap for both separation and removal of unfused powder.

In the example shown in FIG. 9, the resonance can be applied via mechanical conduction directly or indirectly through the build piece. While FIG. 9 shows the vibrator 990 connected to or in contact with the build piece 905 the vibrator 990 may be connected to or indirectly connected to any one or combination of the support structure, the build plate, etc.

FIG. 10 shows an example system and method that includes a resonation device 1090 with a resonator and/or vibrator 990 that can apply a resonance frequency to a support structure 1009 for removing the support structures 1009 and/or unfused powder. The vibrator 1090 may cause mechanical excitation via for example any one or combination of ultrasound transducers, piezoelectric transducers micro electro-mechanical systems, to name a few non-limiting examples.

FIG. 10 shows a build plate 1001 and a build piece 1005. It is noted that while the support structure 1009 is indicated as a lattice type support structure, the features described are applicable to any type of support structure. For example, the resonator may be used to remove any one or combination of the support structures 300 in FIG. 3, 400 in FIG. 4, 500 in FIG. 5, and/or 617a and 617b in FIGS. 6A-6B.

The resonator/vibrator 1009 can be coupled to and/or may be configured to contact the support structure 1009 such that a resonance frequency can be applied to cause the support structures 1009 to vibrate or resonate. In some examples, the resonator/vibrator 1009 may apply a resonation at a resonance frequency or half-resonance frequency of resonance structures (e.g., resonance structures 655b in FIGS. 6B-6D). The resonance may cause failure, and thus separation, of the fused support at a designated failure zone 1017. The designated failure zone may share similarities with or may be analogous with the failure zones 317 and/or 319 in FIG. 3, 417 in FIG. 4, or 517 and/or 519 in FIG. 5, for example. The vibrator 990 may be controlled to induce vibrations from 50 Hertz (Hz) to 1000 Hz. In another example, the vibrator 1090 may induce vibrations from 100-900 Hz. In yet another example 200-900 Hz. In some examples, the vibrator 1090 may induce higher-frequency vibrations either concurrently with and/or before and/or after the aforementioned frequencies. Some examples of higher-frequency vibrations may be 900-2000 Hz, 950-1950 Hz and/or 1100-1900 Hz. Combining high frequencies with low frequencies may increase the efficiency of separating the support structure(s) 1009 from the build piece 1005 and/or a build plate 1001. In various embodiments, the vibrator 990 may induce a first frequency that is tuned to cause vibrations of the support structure that are more effective at removing unfused powder, e.g., a relatively lower frequency to cause greater deflection of the resonant structures of the support structure (e.g., resonant structures 655b). In various embodiments, after the unfused powder is removed, the vibrator 990 may induce a second frequency that is tuned to cause vibrations of the support structure that are more effective at causing fatigue and breaking the support structure, e.g., a relatively higher frequency to cause a higher rate of deflection back and forth of the resonant structures to induce high-cycle fatigue stress.

In the example shown in FIG. 10, the resonance can be applied via mechanical conduction directly or indirectly through the support structure 1009. While FIG. 10 shows the vibrator 1090 connected to or in contact with the support structure 1009, the vibrator 1090 may be connected to or indirectly connected to any one or combination of the support structure, the build plate, etc. For example, in one aspect the vibrator 990 described above with respect to FIG. 9 may be implemented into the resonation device 1000 of FIG. 10 so that both the support structure 1009 and the build piece 1005 may be mechanically excited to further improve efficiency of separation of the support structure and/or any unfused powder.

It is noted that the aforementioned operations are provided as examples. While some specific examples are given, one having ordinary skill in the art would understand that additional possibilities of automated, semi-automated, or manual control of the systems and devices of the disclosed support system formation and removal methods and apparatuses described herein would fall within the scope of this disclosure after understanding the disclosure provided herein.

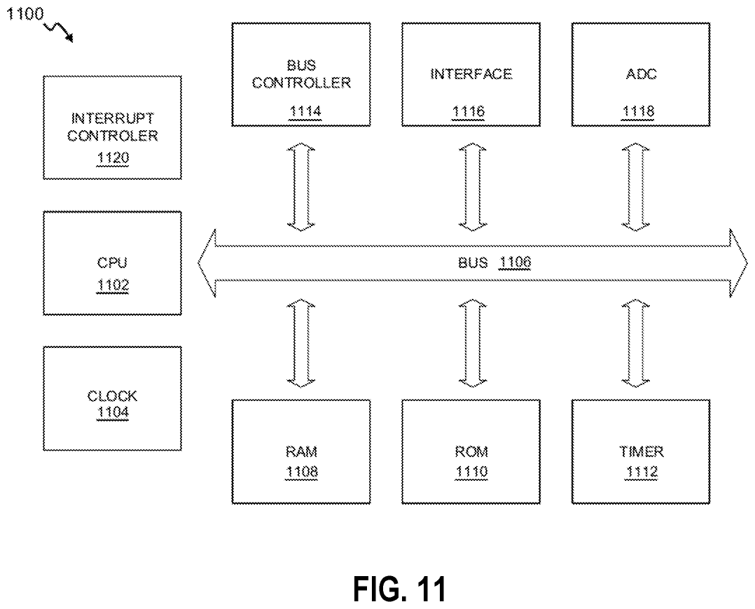

In some implementations, as part of or incorporating various features and methods described herein, one or more microcontrollers may be implemented for controlling any one or combination of the operations described herein (e.g., the operations of the PBF system and/or support removal systems and apparatuses described herein). Various components of an example of such a controller 1100 are shown in representative block diagram form in FIG. 11. In FIG. 11, the controller 1100 includes a CPU 1102, clock 1104, RAM 1108, ROM 1110, a timer 1112, a BUS controller 1114, an interface 1116, and an analog-to-digital converter (ADC) 1118 interconnected via a BUS 1106. The CPU 1102 may be implemented as one or more single core or multi-core processors, and receive signals from an interrupt controller 1120 and a clock 1104. The clock 1104 may set the operating frequency of the entire microcontroller 1100 and may include one or more crystal oscillators having predetermined frequencies. Alternatively, the clock 1104 may receive an external clock signal. The interrupt controller 1120 may also send interrupt signals to the CPU, to suspend CPU operations. The interrupt controller 1120 may transmit an interrupt signal to the CPU when an event requires immediate CPU attention.

The RAM 1108 may include one or more Static Random Access Memory (SRAM), Dynamic Random Access Memory (DRAM), Synchronous Dynamic Random Access Memory (SDRAM), Double Data-Rate Random Access Memory (DDR SDRAM), or other suitable volatile memory. The Read-only Memory (ROM) 1110 may include one or more Programmable Read-only Memory (PROM), Erasable Programmable Read-only Memory (EPROM), Electronically Erasable Programmable Read-only memory (EEPROM), flash memory, or other types of non-volatile memory.

The timer 1112 may keep time and/or calculate the amount of time between events occurring within the controller 1100, count the number of events, and/or generate baud rate for communication transfer. The BUS controller 1114 may prioritize BUS usage within the controller 1100. The ADC 1118 may allow the controller 1100 to send out pulses to signal other devices.

The interface 1116 may comprise an input/output device that allows the controller 1100 to exchange information with other devices. In some implementations, the interface 1116 may include one or more of a parallel port, a serial port, or other computer interfaces.

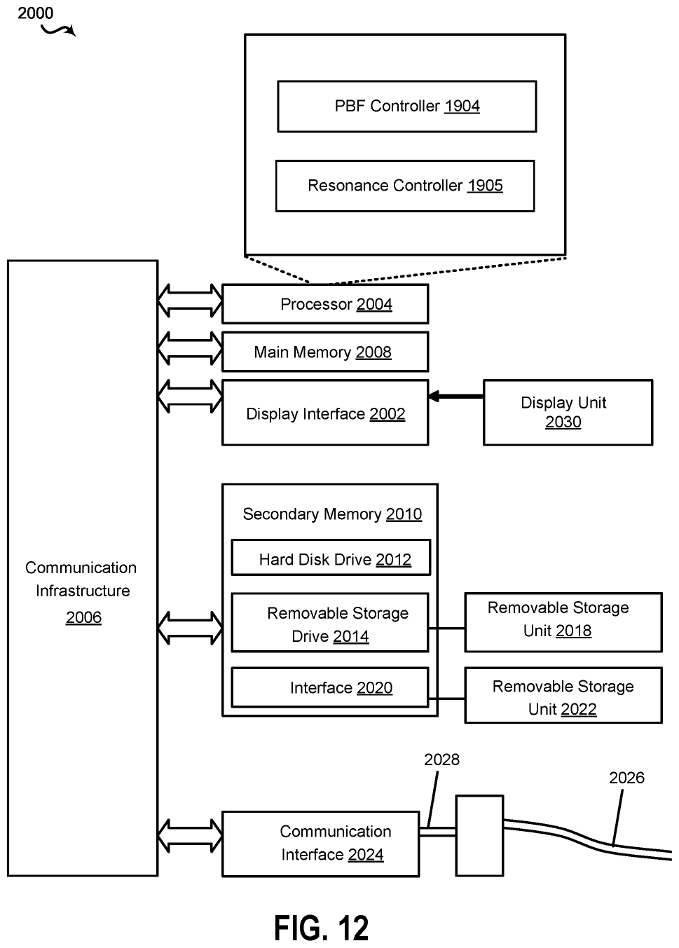

In addition, aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 2000 is shown in FIG. 12.

The computer system 2000 may include one or more processors, such as processor 2004. The processor 2004 may be connected to a communication infrastructure 2006 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 2000 may include a display interface 2002 that forwards graphics, text, and other data from the communication infrastructure 2006 (or from a frame buffer not shown) for display on a display unit 2030, which may be analogous with the display interface 102. Computer system 2000 also includes a main memory 2008, preferably random access memory (RAM), and may also include a secondary memory 2010. The secondary memory 2010 may include, for example, a hard disk drive 2012, and/or a removable storage drive 2014, representing a floppy disk drive, a magnetic tape drive, an optical disk drive, a universal serial bus (USB) flash drive, etc. The removable storage drive 2014 reads from and/or writes to a removable storage unit 2018 in a well-known manner. Removable storage unit 2018 represents a floppy disk, magnetic tape, optical disk, USB flash drive etc., which is read by and written to removable storage drive 2014. As will be appreciated, the removable storage unit 2018 includes a computer usable storage medium having stored therein computer software and/or data.

Alternative aspects of the present disclosure may include secondary memory 2010 and may include other similar devices for allowing computer programs or other instructions to be loaded into computer system 2000. Such devices may include, for example, a removable storage unit 2022 and an interface 2020. Examples of such may include a program cartridge and cartridge interface (such as that found in video game devices), a removable memory chip (such as an erasable programmable read only memory (EPROM), or programmable read only memory (PROM)) and associated socket, and other removable storage units 2022 and interfaces 2020, which allow software and data to be transferred from the removable storage unit 2022 to computer system 2000.

Computer system 2000 may also include a communications interface 2024. Communications interface 2024 allows software and data to be transferred between computer system 2000 and external devices. Examples of communications interface 2024 may include a modem, a network interface (such as an Ethernet card), a communications port, a Personal Computer Memory Card International Association (PCMCIA) slot and card, etc. Software and data transferred via communications interface 2024 are in the form of signals 2028, which may be electronic, electromagnetic, optical or other signals capable of being received by communications interface 2024. These signals 2028 are provided to communications interface 2024 via a communications path (e.g., channel) 2026. This path 2026 carries signals 2028 and may be implemented using wire or cable, fiber optics, a telephone line, a cellular link, an RF link and/or other communications channels. In this document, the terms “computer program medium” and “computer usable medium” are used to refer generally to media such as a removable storage drive 2018, a hard disk installed in hard disk drive 2012, and signals 2028. These computer program products provide software to the computer system 2000. Aspects of the present disclosures are directed to such computer program products.

Computer programs (also referred to as computer control logic) are stored in main memory 2008 and/or secondary memory 2010. Computer programs may also be received via communications interface 2024. Such computer programs, when executed, enable the computer system 2000 to perform the features in accordance with aspects of the present disclosures, as discussed herein. In particular, the computer programs, when executed, enable the processor 2004 to perform the features in accordance with aspects of the present disclosures. Accordingly, such computer programs represent controllers of the computer system 2000.

In an aspect of the present disclosures where the method is implemented using software, the software may be stored in a computer program product and loaded into computer system 2000 using removable storage drive 2014, hard drive 2012, or communications interface 2020. The control logic (software), when executed by the processor 2004, causes the processor 2004 to perform the functions described herein. In some examples, the computer system 2000 may include one or more PBF controller(s) 1904, e.g., for controlling any one or combination of the PBF systems described above with respect to FIGS. 1A-7) and/or any one or combination of resonance controller(s) 1905, which may for example control any one or combination of the features described above with respect to FIGS. 8-10. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

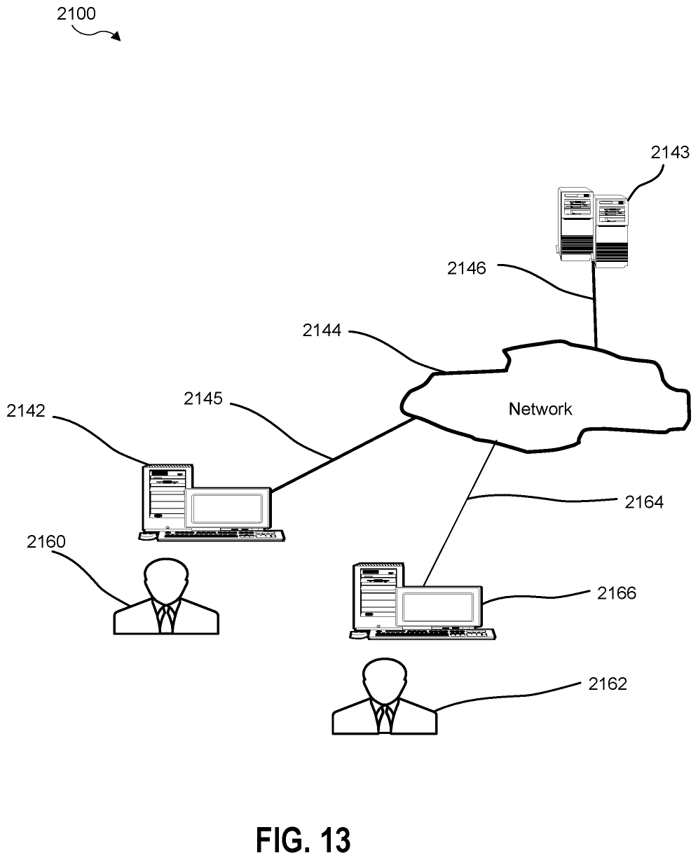

FIG. 13 is a block diagram of various example communication system components usable in accordance with an aspect of the present disclosure. The communication system 2100 includes one or more accessors 2160, 2162 (which may for example comprise any of the aforementioned systems and features) and one or more terminals 2142, 2166. In one aspect, data for use in accordance with aspects of the present disclosure is, for example, input and/or accessed by accessors 2160, 2162 via terminals 2142, 2166, such as personal computers (PCs), minicomputers, mainframe computers, microcomputers, telephonic devices, or wireless devices, such as personal digital assistants (“PDAs”) or a hand-held wireless devices coupled to a server 2143, such as a PC, minicomputer, mainframe computer, microcomputer, or other device having a processor and a repository for data and/or connection to a repository for data, via, for example, a network 2144, such as the Internet or an intranet, and couplings 2145, 2146, 2164. The couplings 2145, 2146, 2164 include, for example, wired, wireless, or fiberoptic links. In another example variation, the method and system in accordance with aspects of the present disclosure operate in a stand-alone environment, such as on a single terminal.

Additional aspects of the disclosure are described in the clauses that follow:

Clause 1. A device for processing an additively manufactured component and support structure, the device comprising: a resonation device for resonating at least the additively manufactured component or support structure, wherein the resonation device is configured to resonate the support structure at a frequency that causes structural failure and separation of the support structure from the additively manufactured component.

Clause 2. The device of clause 1, wherein the resonation device is a transducer.

Clause 3. The device of any of the above clauses, wherein the transducer is configured to oscillate when electrical current is provided thereto via an ultrasonic generator, wherein the transducer oscillates at least the additively manufactured component or support structure at said frequency.

Clause 4. The device any of the above clauses, wherein the transducer is configured to contact at least the additively manufactured component or support structure.

Clause 5. The device any of the above clauses, wherein the frequency is 1100-1900 hertz (Hz).

Clause 6. The device of any of the above clauses, further configured to resonate at least the additively manufactured component or support structure at a second resonation frequency that separates non-fused additive media from the additively manufactured component.

Clause 7. The device any of the above clauses, wherein the second resonation frequency is 200-900 Hz.

Clause 8. The device any of the above clauses, further comprising: a liquid container configured to contain a liquid and the additively manufactured component and support structure; and a transducer at the liquid container configured to oscillate when electrical current is provided to the transducer via an ultrasonic generator, wherein the support structure resonates at said frequency via waves that propagate through the liquid in response to oscillation of the transducer.

Clause 9. The device any of the above clauses, further comprising an ultrasonic generator that provides electrical current to the transducer.

Clause 10. The device any of the above clauses, further comprising: a build plate configured to have the additively manufactured component and support structure formed thereon; an energy beam supply apparatus; and a powder supply apparatus configured to provide a powder to be sintered or melted by the energy beam supply apparatus; wherein once a first layer of power is supplied by the powder supply apparatus and sintered or melted by the energy beam supply apparatus, the build plate is configured to retract and the powder supply apparatus is configured to provide a second layer of powder to be sintered or melted by the energy beam supply apparatus.

Clause 11. The device of any of the above clauses, wherein the energy beam supply apparatus is a laser.

Clause 12. A device for processing an additively manufactured component, the device comprising: a resonation device for resonating least one of the additively manufactured component or an additively manufactured support structure connected to the additively manufactured component, wherein the resonation device is configured to resonate at least the support structure or component at a frequency that separates non-fused additive media from the additively manufactured component.

Clause 13. The device of clause 12, wherein the resonation device is a transducer.

Clause 14. The device any of the above clauses, wherein the transducer is configured to oscillate when electrical current is provided thereto via an ultrasonic generator, wherein the transducer oscillates at least the additively manufactured component or support structure at said frequency.

Clause 15. The device any of the above clauses, wherein the transducer is configured to contact at least the additively manufactured component or support structure.

Clause 16. The device any of the above clauses, wherein the frequency is 200-900 hertz (Hz).

Clause 17. The device of any of the above clauses, further configured to resonate the support structure at a second resonation frequency that causes structural failure and separation of the support structure from the additively manufactured component.

Clause 18. The device of any of the above clauses, wherein the second resonation frequency is 1100-1900 Hz.

Clause 19. The device of any of the above clauses, further comprising: a liquid container configured to contain a liquid and the additively manufactured component and support structure; and a transducer at the liquid container configured to oscillate when electrical current is provided thereto via an ultrasonic generator, wherein at least the additively manufactured component or support structure resonates at said frequency via waves that propagate through the liquid in response to oscillation of the transducer.

Clause 20. The device of any of the above clauses, further comprising an ultrasonic generator that provides electrical current to the transducer.

Clause 21. The device any of the above clauses, wherein the transducer is configured to oscillate when electrical current is provided thereto via an ultrasonic generator, wherein the transducer oscillates at least the additively manufactured component or support structure at said frequency.

Clause 22. The device of any of the above clauses, further comprising: a build plate configured to have the additively manufactured component and support structure formed thereon; an energy beam supply apparatus; and a powder supply apparatus configured to provide a powdered build material to be fused by the energy beam supply apparatus; wherein once a first layer of powdered build material is supplied by the powder supply apparatus and fused by the energy beam supply apparatus, the build plate is configured to retract and the powder supply apparatus is configured to provide a second layer of powdered build material to be sintered or fused by the energy beam supply apparatus.

Clause 23. The device of any of the above clauses, wherein the energy beam supply apparatus is a laser.

Clause 24. A method of additively manufacturing a build piece and a support structure for mechanically supporting at least part of the build piece, the method comprising: layered fusing of a powdered build material to form the support structure; and layered fusing of the powdered build material to form the build piece; wherein the support structure is formed with a failure zone proximal to the build piece, wherein the failure zone is configured to structurally fail and separate from the build piece when subjected to resonation by a resonation device.

Clause 25. The method of clause 24, wherein the failure zone is formed by increasing or decreasing a volumetric energy density (VED) to introduce structural defects in the support structure at the failure zone, wherein the VED in joules/millimeters3 (J/mm3) is defined by the following equation: wherein E is a power of an energy source used to fuse the powdered build material, S is a scan speed of the energy source, L is a thickness of unfused powdered build material, and H is a hatch spacing of the energy source used to fuse the powdered build material.

Clause 26. The method of any of the above clauses, wherein the VED at the failure zone is 40-80 J/mm3.

Clause 27. The method of any of the above clauses, wherein the VED at the failure zone is 1-25 J/mm3.

Clause 28. The method of any of the above clauses, wherein the failure zone is one or more layers of the support structure that are in contact with and are to be removed from the build piece.

Clause 29. The method of of any of the above clauses, where the layered fusing of a powdered build material to form the support structure comprises: providing a layer of the powdered build material via a powder supply apparatus and fusing the powdered build material via a laser or electron beam to form a failure zone layer of the support structure, and wherein the layered fusing of the powdered build material to form the build piece comprises: providing a layer of the powdered build material over the failure zone layer of the support structure via the powder supply apparatus and fusing the powdered build material via the laser or electron beam to form a build piece layer that is supported by the failure zone layer of the support structure.

Clause 30. The method of any of the above clauses, wherein the failure zone layer of the support structure is formed with a volumetric energy density (VED) in joules/millimeters3 (J/mm3) of 10-40% higher or lower than the build piece layer, wherein VED is defined by the following equation: wherein E is a power of the laser or electron beam, S is a scan speed of the laser or electron beam, L is a thickness of unfused powdered build material, and H is a hatch spacing of the laser or electron beam during fusing of the powdered build material.

Clause 31. The method of any of the above clauses, wherein the failure zone layer is formed with VED of 20-40% higher than the build piece layer.

Clause 32. The method of any of the above clauses, wherein the failure zone layer is formed with a VED of 20-40% lower than the build piece layer.

Clause 33. The method of any of the above clauses, further comprising: resonating the support structure via a resonation device, wherein resonating the support structure causes structural failure and separation of the support structure from the build piece at the failure zone.

Clause 34. The method of any of the above clauses, further comprising: resonating at least the support structure or the build piece via a resonation device, wherein resonating the at least the support structure or build piece causes separation of unfused powdered build material from the build piece.

Clause 35. A non-transitory computer-readable medium storing computer-executable instructions for additive manufacturing, the instructions executable by a processor to control an additive manufacturing apparatus to perform: layered fusing of a powdered build material to form a support structure for a build piece; and layered fusing of the powdered build material to form the build piece; wherein the support structure is formed with a failure zone proximal to the build piece, wherein the failure zone is configured to structurally fail and separate from the build piece when subjected to resonation by a resonation device.

Clause 36. The non-transitory computer-readable medium storing computer-executable instructions of clause 35, wherein the instructions are further executable by a processor to control an additive manufacturing apparatus to increase or decrease a volumetric energy density (VED) to introduce structural defects in the support structure at the failure zone, wherein the VED in Joules/millimeters3 (J/mm3) is defined by the following equation: wherein E is a power of an energy source used to fuse the powdered build material, S is a scan speed of the energy source, L is a thickness of unfused powdered build material, and H is a hatch spacing used when fusing the powdered build material via the energy source.

Clause 37. The non-transitory computer-readable medium storing computer-executable instructions of any of the above clauses, wherein the VED at the failure zone is 40-80 J/mm3.

Clause 38. The non-transitory computer-readable medium storing computer-executable instructions of of any of the above clauses, wherein the VED at the failure zone is 1-25 J/mm3.

Clause 39. The non-transitory computer-readable medium storing computer-executable instructions of any of the above clauses, wherein the failure zone is one or more layers of the support structure that are in contact with and are to be removed from the build piece.

Clause 40. The non-transitory computer-readable medium storing computer-executable instructions for additive manufacturing of any of the above clauses, wherein layered fusing of a powdered build material to form the support structure comprises: providing a layer of the powdered build material via a powder supply apparatus and fusing the powdered build material via a laser or electron beam to form a failure zone layer of the failure zone of the support structure, and wherein the layered fusing of the powdered build material to form the build piece comprises: providing a layer of the powdered build material over the failure zone layer of the support structure via the powder supply apparatus and fusing the powdered build material via the laser or electron beam to form a build piece layer that is supported by the failure zone layer of the support structure.

Clause 41. The non-transitory computer-readable medium storing computer-executable instructions for additive manufacturing of any of the above clauses, wherein the failure zone layer is formed with a volumetric energy density (VED) in joules/millimeters3 (J/mm3) of 10-40% higher or lower than the build piece layer, wherein VED is defined by the following equation: wherein E is a power of the laser or electron beam, S is a scan speed of the laser or electron beam, L is a thickness of unfused powdered build material, and H is a hatch spacing of the laser or electron beam in fusing of the powdered build material.

Clause 42. The non-transitory computer-readable medium storing computer-executable instructions for additive manufacturing of any of the above clauses, wherein the failure zone layer is formed with VED of 20-40% higher than the build piece layer.

Clause 43. The non-transitory computer-readable medium storing computer-executable instructions for additive manufacturing of any of the above clauses, wherein the failure zone layer is formed with a VED of 20-40% lower than the build piece layer.

Clause 44. The non-transitory computer-readable medium storing computer-executable instructions for additive manufacturing of any of the above clauses, further comprising: resonating the support structure via a resonation device, wherein resonating the support structure causes structural failure and separation of the support structure from the build piece at the failure zone.

Clause 45. The non-transitory computer-readable medium storing computer-executable instructions for additive manufacturing of any of the above clauses, further comprising: resonating at least the support structure or the build piece via a resonation device, wherein resonating the at least the support structure or build piece causes separation of unfused powdered build material from the build piece.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other support structures and systems and methods for removal of support structures. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A device for processing an additively manufactured component and support structure, the device comprising:
a resonation device for resonating at least the additively manufactured component or support structure, wherein the resonation device is configured to resonate the support structure at a frequency that causes structural failure and separation of the support structure from the additively manufactured component.

2. The device of claim 1, wherein the resonation device is a transducer.

3. The device of claim 2, wherein the transducer is configured to oscillate when electrical current is provided thereto via an ultrasonic generator, wherein the transducer oscillates at least the additively manufactured component or support structure at said frequency.

4. The device of claim 3, wherein the transducer is configured to contact at least the additively manufactured component or support structure.

5. The device of claim 1, wherein the frequency is 1100-1900 hertz (Hz).

6. The device of claim 1, further configured to resonate at least the additively manufactured component or support structure at a second resonation frequency that separates non-fused additive media from the additively manufactured component.

7. The device of claim 6, wherein the second resonation frequency is 200-900 Hz.

8. The device of claim 1, further comprising:
a liquid container configured to contain a liquid and the additively manufactured component and support structure; and
a transducer at the liquid container configured to oscillate when electrical current is provided to the transducer via an ultrasonic generator, wherein the support structure resonates at said frequency via waves that propagate through the liquid in response to oscillation of the transducer.

9. The device of claim 8, further comprising an ultrasonic generator that provides electrical current to the transducer.

10. The device of claim 1, further comprising:
a build plate configured to have the additively manufactured component and support structure formed thereon;
an energy beam supply apparatus; and
a powder supply apparatus configured to provide a powder to be sintered or melted by the energy beam supply apparatus; wherein once a first layer of power is supplied by the powder supply apparatus and sintered or melted by the energy beam supply apparatus, the build plate is configured to retract and the powder supply apparatus is configured to provide a second layer of powder to be sintered or melted by the energy beam supply apparatus.

11. The device of claim 10, wherein the energy beam supply apparatus is a laser.

12. A device for processing an additively manufactured component, the device comprising:
a resonation device for resonating least one of the additively manufactured component or an additively manufactured support structure connected to the additively manufactured component, wherein the resonation device is configured to resonate at least the support structure or component at a frequency that separates non-fused additive media from the additively manufactured component.

13. The device of claim 12, wherein the resonation device is a transducer.

14. The device of claim 13, wherein the transducer is configured to oscillate when electrical current is provided thereto via an ultrasonic generator, wherein the transducer oscillates at least the additively manufactured component or support structure at said frequency.

15. The device of claim 14, wherein the transducer is configured to contact at least the additively manufactured component or support structure.

16. The device of claim 12, wherein the frequency is 200-900 hertz (Hz).

17. The device of claim 12, further configured to resonate the support structure at a second resonation frequency that causes structural failure and separation of the support structure from the additively manufactured component.

18. The device of claim 17, wherein the second resonation frequency is 1100-1900 Hz.

19. The device of claim 12, further comprising:
a liquid container configured to contain a liquid and the additively manufactured component and support structure; and
a transducer at the liquid container configured to oscillate when electrical current is provided thereto via an ultrasonic generator, wherein at least the additively manufactured component or support structure resonates at said frequency via waves that propagate through the liquid in response to oscillation of the transducer.

20. The device of claim 19, further comprising an ultrasonic generator that provides electrical current to the transducer.

21. The device of claim 13, wherein the transducer is configured to oscillate when electrical current is provided thereto via an ultrasonic generator, wherein the transducer oscillates at least the additively manufactured component or support structure at said frequency.

22. The device of claim 12, further comprising:
a build plate configured to have the additively manufactured component and support structure formed thereon;
an energy beam supply apparatus; and
a powder supply apparatus configured to provide a powdered build material to be fused by the energy beam supply apparatus; wherein once a first layer of powdered build material is supplied by the powder supply apparatus and fused by the energy beam supply apparatus, the build plate is configured to retract and the powder supply apparatus is configured to provide a second layer of powdered build material to be sintered or fused by the energy beam supply apparatus.

23. The device of claim 22, wherein the energy beam supply apparatus is a laser.

24. A method of additively manufacturing a build piece and a support structure for mechanically supporting at least part of the build piece, the method comprising:
layered fusing of a powdered build material to form the support structure; and
layered fusing of the powdered build material to form the build piece; wherein the support structure is formed with a failure zone proximal to the build piece, wherein the failure zone is configured to structurally fail and separate from the build piece when subjected to resonation by a resonation device.

25. The method of claim 24, wherein the failure zone is formed by increasing or decreasing a volumetric energy density (VED) to introduce structural defects in the support structure at the failure zone, wherein the VED in joules/millimeters 3 (J/mm3) is defined by the following equation:
$$VED = \frac{E}{S \times L \times H}$$
wherein E is a power of an energy source used to fuse the powdered build material, S is a scan speed of the energy source, L is a thickness of unfused powdered build material, and H is a hatch spacing of the energy source used to fuse the powdered build material.

26. The method of claim 25, wherein the VED at the failure zone is 40-80 J/mm³.

27. The method of claim 25, wherein the VED at the failure zone is 1-25 J/mm³.

28. The method of claim 24 wherein the failure zone is one or more layers of the support structure that are in contact with and are to be removed from the build piece.

29. The method of claim 24, where the layered fusing of a powdered build material to form the support structure comprises:
providing a layer of the powdered build material via a powder supply apparatus and fusing the powdered build material via a laser or electron beam to form a failure zone layer of the support structure, and wherein the layered fusing of the powdered build material to form the build piece comprises:
providing a layer of the powdered build material over the failure zone layer of the support structure via the powder supply apparatus and fusing the powdered build material via the laser or electron beam to form a build piece layer that is supported by the failure zone layer of the support structure.

30. The method of claim 29, wherein the failure zone layer of the support structure is formed with a volumetric energy density (VED) in joules/millimeters³ (J/mm³) of 10-40% higher or lower than the build piece layer, wherein VED is defined by the following equation:
$$VED = \frac{E}{S \times L \times H}$$
wherein E is a power of the laser or electron beam, S is a scan speed of the laser or electron beam, L is a thickness of unfused powdered build material, and H is a hatch spacing of the laser or electron beam during fusing of the powdered build material.

31. The method of claim 30, wherein the failure zone layer is formed with VED of 20-40% higher than the build piece layer.

32. The method of claim 30, wherein the failure zone layer is formed with a VED of 20-40% lower than the build piece layer.

33. The method of claim 24, further comprising:
resonating the support structure via a resonation device, wherein resonating the support structure causes structural failure and separation of the support structure from the build piece at the failure zone.

34. The method of claim 24, further comprising:
resonating at least the support structure or the build piece via a resonation device, wherein resonating the at least the support structure or build piece causes separation of unfused powdered build material from the build piece.

35. A non-transitory computer-readable medium storing computer-executable instructions for additive manufacturing, the instructions executable by a processor to control an additive manufacturing apparatus to perform:
layered fusing of a powdered build material to form a support structure for a build piece; and
layered fusing of the powdered build material to form the build piece; wherein the support structure is formed with a failure zone proximal to the build piece, wherein the failure zone is configured to structurally fail and separate from the build piece when subjected to resonation by a resonation device.

36. The non-transitory computer-readable medium storing computer-executable instructions of claim 35, wherein the instructions are further executable by a processor to control an additive manufacturing apparatus to increase or decrease a volumetric energy density (VED) to introduce structural defects in the support structure at the failure zone, wherein the VED in Joules/millimeters³ (J/mm³) is defined by the following equation:
$$VED = \frac{E}{S \times L \times H}$$
wherein E is a power of an energy source used to fuse the powdered build material, S is a scan speed of the energy source, L is a thickness of unfused powdered build material, and H is a hatch spacing used when fusing the powdered build material via the energy source.

37. The non-transitory computer-readable medium storing computer-executable instructions of claim 36, wherein the VED at the failure zone is 40-80 J/mm³.

38. The non-transitory computer-readable medium storing computer-executable instructions of claim 36, wherein the VED at the failure zone is 1-25 J/mm³.

39. The non-transitory computer-readable medium storing computer-executable instructions of claim 35, wherein the failure zone is one or more layers of the support structure that are in contact with and are to be removed from the build piece.

40. The non-transitory computer-readable medium storing computer-executable instructions for additive manufacturing of claim 35, wherein layered fusing of a powdered build material to form the support structure comprises:
providing a layer of the powdered build material via a powder supply apparatus and fusing the powdered build material via a laser or electron beam to form a failure zone layer of the failure zone of the support structure, and wherein the layered fusing of the powdered build material to form the build piece comprises:
providing a layer of the powdered build material over the failure zone layer of the support structure via the powder supply apparatus and fusing the powdered build material via the laser or electron beam to form a build piece layer that is supported by the failure zone layer of the support structure.

41. The non-transitory computer-readable medium storing computer-executable instructions for additive manufacturing of claim 40, wherein the failure zone layer is formed with a volumetric energy density (VED) in joules/millimeters³ (J/mm³) of 10-40% higher or lower than the build piece layer, wherein VED is defined by the following equation:
$$VED = \frac{E}{S \times L \times H}$$
wherein E is a power of the laser or electron beam, S is a scan speed of the laser or electron beam, L is a thickness of unfused powdered build material, and H is a hatch spacing of the laser or electron beam in fusing of the powdered build material.

42. The non-transitory computer-readable medium storing computer-executable instructions for additive manufacturing of claim 41, wherein the failure zone layer is formed with VED of 20-40% higher than the build piece layer.

43. The non-transitory computer-readable medium storing computer-executable instructions for additive manufacturing of claim 41, wherein the failure zone layer is formed with a VED of 20-40% lower than the build piece layer.

44. The non-transitory computer-readable medium storing computer-executable instructions for additive manufacturing of claim 35, further comprising:
resonating the support structure via a resonation device, wherein resonating the support structure causes structural failure and separation of the support structure from the build piece at the failure zone.

45. The non-transitory computer-readable medium storing computer-executable instructions for additive manufacturing of claim 35, further comprising:
resonating at least the support structure or the build piece via a resonation device, wherein resonating the at least the support structure or build piece causes separation of unfused powdered build material from the build piece.
